(19) United States
(12) Patent Application Publication
(10) Pub. No.: US 2026/0318016 A1
(43) Pub. Date: Oct. 15, 2026

(54) SCREED

(71) Applicant: MAKITA CORPORATION, Anjo-shi (JP)

(72) Inventors: Yuji SAKAKIBARA, Anjo-shi (JP); Masaya SATO, Anjo-shi (JP)

(73) Assignee: MAKITA CORPORATION, Anjo-shi (JP)

(21) Appl. No.: 19/467,623

(22) Filed: Feb. 2, 2026

(30) Foreign Application Priority Data
Feb. 5, 2025 (JP) 2025-017471
Aug. 6, 2025 (JP) 2025-131639

(51) Int. Cl. E01C 19/40

(52) U.S. Cl. CPC E01C 19/402

(57) ABSTRACT

A screed may include: a motor; a housing accommodating the motor, wherein the housing comprises a first mounting portion to which a battery pack or an adapter is detachably attached; a tubular operation rod constituted of metal, wherein the operation rod extends from the housing toward a first side in a specific direction and accommodates a drive shaft connected to the motor; an eccentric member accommodating part disposed on the first side to the operation rod in the specific direction, wherein the eccentric member accommodating part accommodates an eccentric member connected to the drive shaft and a plurality of bearings that support the eccentric member such that the eccentric member is rotatable; a connector connecting the operation rod to the eccentric member accommodating part in the specific direction; and a leveler connected to the eccentric member accommodating part.

### CROSS REFERENCE TO RELATED APPLICATIONS

This application claims priority to Japanese Patent Application No. 2025-017471 filed on Feb. 5, 2025 and Japanese Patent Application No. 2025-131639 filed on Aug. 6, 2025. The entire contents of the priority applications are incorporated herein by reference.

### TECHNICAL FIELD

The art disclosed herein relates to a screed.

### BACKGROUND ART

Japanese Utility Model Registration No. 3144261 describes a screed including a motor; a housing accommodating the motor therein and including a mounting portion to which a battery pack is detachably attachable; a tubular operation rod constituted of metal, wherein the operation rod extends from the housing toward a first side in a specific direction and accommodates a drive shaft connected to the motor and an eccentric member connected to the drive shaft; and a leveler connected to the operation rod in the specific direction.

### SUMMARY

In the screed described in Japanese Utility Model Registration No. 3144261, the eccentric member and the drive shaft are accommodated in the operation rod. Generally, screeds comprise a plurality of bearings supporting an eccentric member such that the eccentric member is rotatable. The rotation of eccentric member causes rotational vibration. Therefore, a portion of the operation rod where the plurality of bearings is held may be subjected to a relatively large load. In order to prevent damage to the operation rod, it is required to increase the overall thickness of the operation rod to accommodate the load on the portion of the operation rod where the plurality of bearings is held. However, this leads to a weight increase of the screed.

The disclosure herein provides a technology allowing for a weight reduction of a screed.

A screed disclosed herein may comprise: a motor; a housing accommodating the motor, wherein the housing comprises a first mounting portion to which a battery pack or an adapter is detachably attached; a tubular operation rod constituted of metal, wherein the operation rod extends from the housing toward a first side in a specific direction and accommodates a drive shaft connected to the motor; an eccentric member accommodating part disposed on the first side to the operation rod in the specific direction, wherein the eccentric member accommodating part accommodates an eccentric member connected to the drive shaft and a plurality of bearings that support the eccentric member such that the eccentric member is rotatable; a connector connecting the operation rod to the eccentric member accommodating part in the specific direction; and a leveler connected to the eccentric member accommodating part.

In the configuration above, the operation rod accommodating the drive shaft and the eccentric member accommodating part accommodating the eccentric member are separate components. Therefore, the thickness of the operation rod can be reduced compared to the thickness of the eccentric member accommodating part. This allows for a weight reduction of the operation rod, thus allows for a weight reduction of the screed.

### BRIEF DESCRIPTION OF DRAWINGS

FIG. 1 is a perspective view of a screed 2 according to an embodiment as viewed from the upper front right side.

FIG. 2 is a right cross-sectional view of the screed 2 according to the embodiment.

FIG. 3 is a perspective view of a front end portion of an operation rod 4 according to an embodiment as viewed from the upper front left side.

FIG. 4 is a right cross-sectional view of a vicinity of a loop handle 6 according to an embodiment.

FIG. 5 is a perspective view of a vicinity of a housing 8 according to an embodiment as viewed from the upper front left side.

FIG. 6 is a right cross-sectional view of a vicinity of the housing 8 according to the embodiment.

FIG. 7 is a perspective view of an elastic member 90 according to an embodiment as viewed from the upper front right side.

FIG. 8 is a rear cross-sectional view of a fastening portion 88A of a retainer 70 according to an embodiment.

FIG. 9 is a rear cross-sectional view of a fastening portion 88B of the retainer 70 according to an embodiment.

FIG. 10 is a right cross-sectional view of a vicinity of an eccentric member accommodating part 14 according to an embodiment.

FIG. 11 is a perspective view of an eccentric member 102 according to an embodiment as viewed from the upper rear right side.

FIG. 12 is a perspective view of a vicinity of a leveler unit 16 according to an embodiment as viewed from the upper front left side, where a lever 174 is in a clamp position.

FIG. 13 is a rear cross-sectional view of an upper fastening portion 130 of a front connector 12 according to an embodiment.

FIG. 14 is a rear cross-sectional view of a lower fastening portion 132 of the front connector 12 according to an embodiment.

FIG. 15 is a rear cross-sectional view of an upper fastening portion 140 of the front connector 12 according to an embodiment.

FIG. 16 is a rear cross-sectional view of a lower fastening portion 142 of the front connector 12 according to an embodiment.

FIG. 17 is a rear cross-sectional view of a vicinity of a projection 172 of the leveler unit 16 according to an embodiment.

FIG. 18 is a right cross-sectional view of a vicinity of the lever 174 of the leveler unit 16 according to an embodiment.

FIG. 19 is a perspective view of a vicinity of the leveler unit 16 as viewed from the upper front left side, where the lever 174 is in an unclamp position.

FIG. 20 is a perspective view of the screed 2 according to an embodiment as viewed from the upper front right, where the leveler unit 16 is detached from the front connector 12.

FIG. 21 is a perspective view of an adapter AD according to a first modification as viewed from the upper rear left side.

FIG. 22 is a right cross-sectional view of a vicinity of an eccentric member accommodating part 14 according to a third modification.

FIG. 23 is a right cross-sectional view of a vicinity of an eccentric member accommodating part 14 according to a fourth modification.

FIG. 24 is a right side view of the screed 2 according to an embodiment with a shoulder strap 400 attached thereto.

FIG. 25 is a right side view of the screed 2 according to an embodiment with a tether strap 500 attached thereto.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved screeds.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a screed may comprise: a motor; a housing accommodating the motor, wherein the housing comprises a first mounting portion to which a battery pack or an adapter is detachably attached; a tubular operation rod constituted of metal, wherein the operation rod extends from the housing toward a first side in a specific direction and accommodates a drive shaft connected to the motor; an eccentric member accommodating part disposed on the first side to the operation rod in the specific direction, wherein the eccentric member accommodating part accommodates an eccentric member connected to the drive shaft and a plurality of bearings that support the eccentric member such that the eccentric member is rotatable; a connector connecting the operation rod to the eccentric member accommodating part in the specific direction; and a leveler connected to the eccentric member accommodating part.

In one or more embodiments, the screed may further comprise a second mounting portion coupled to the leveler, wherein the eccentric member accommodating part may be configured to be detachably attached to the second mounting portion. The plurality of bearings may include at least one first bearing and at least one second bearing. The at least one first bearing may be disposed in a first end portion of the eccentric member accommodating part, and the first end portion may be a portion of the eccentric member accommodating part located on a second side in the specific direction, which is opposite to the first side. The at least one second bearing may be disposed in a second end portion of the eccentric member accommodating part and the second end portion may be a portion of the eccentric member accommodating part on the first side. The connector may comprise a first cover configured to cover the first end portion of the eccentric member accommodating part. The second mounting portion may comprise a second cover configured to cover the second end portion of the eccentric member accommodating part.

According to the above configuration, portions of the eccentric member accommodating part where the bearings are located are covered by the first cover and the second cover. This allows for a reduction in the thickness of the eccentric member accommodating part compared to a configuration where the portions of the eccentric member accommodating part are not covered by the covers. Accordingly, the configuration above allows for a weight reduction of the screed.

In one or more embodiments, the connector may comprise at least one of a first clamp configured to clamp the operation rod and a second clamp configured to clamp the eccentric member accommodating part.

The configuration above allows the connector to easily retain at least one of the operation rod and the eccentric member accommodating part.

In one or more embodiments, the connector may comprise both the first clamp and the second clamp.

The configuration above allows the connector to easily retain both the operation rod and the eccentric member accommodating part.

In one or more embodiments, the connector may comprise a projection projecting inward from an outer peripheral portion of the connector. Among the plurality of bearings, a specific bearing positioned at most second-side position in the specific direction may contact the projection. The second side may be opposite to the first side in the specific direction.

The configuration above allows the specific bearing to be positioned in the specific direction by the projection.

In one or more embodiments, a weight of the screed with the battery pack attached to the first mounting portion may be in a range of 5.0 kg to 6.0 kg.

The configuration above improves the operability of the screed for a user.

In one or more embodiments, a size of the screed in the specific direction may be in a range of 1,000 mm to 2,000 mm.

In one or more embodiments, a size of the leveler in a longitudinal direction perpendicular to the specific direction may be in a range of 800 mm to 3,000 mm.

In one or more embodiments, the motor may be a brushless motor.

The configuration above can suppress motor-induced vibrations compared to the motor being a brushed motor. Further, the configuration above can maintain the rotational speed of the motor constant regardless of the remaining charge of the battery pack attached to the first mounting portion.

In one or more embodiments, the screed may further comprise: a second mounting portion coupled to the leveler, wherein the eccentric member accommodating part is configured to be detachably attached to the second mounting portion; and a lever pivotably supported by the second mounting portion. The lever may be configured to move between a first position where the eccentric member accommodating part is attachable to the second mounting portion and a second position where the eccentric member accommodating part is not attachable to the second mounting portion.

The configuration above allows the user to attach the eccentric member accommodating part to the second mounting portion or detach the eccentric member accommodating part from the second mounting portion by operating the lever. Thus, user convenience is improved.

In one or more embodiments, the screed may further comprise a loop handle disposed on the operation rod.

The configuration above improves the operability of the operation rod for the user.

In one or more embodiments, the operation rod and the leveler may be constituted of aluminum, magnesium, or zinc.

The configuration above allows for a weight reduction of the operation rod and the leveler, thus allows for a weight reduction of the screed.

### Embodiments

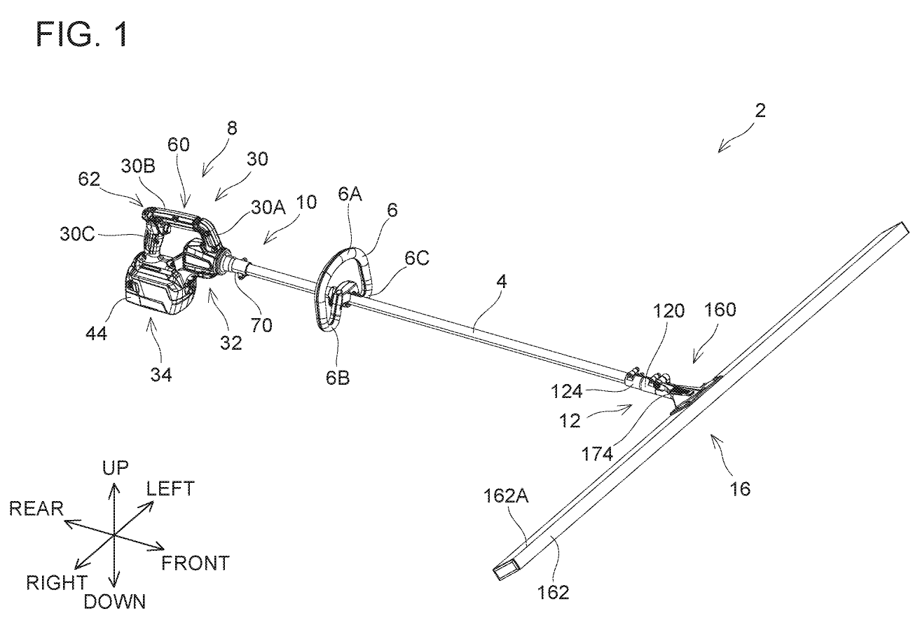

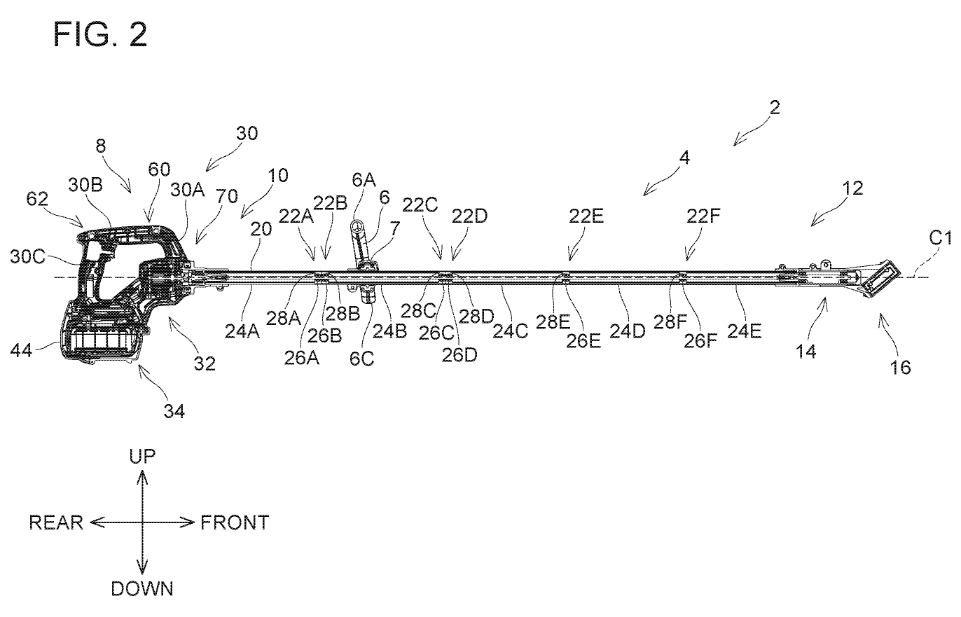

As illustrated in FIG. 1, a screed 2 comprises an operation rod 4, a loop handle 6, a housing 8, a rear connector 10, a front connector 12, an eccentric member accommodating part 14 (see FIG. 2), and a leveler unit 16. The screed 2 is used to level fresh concrete. The screed 2 is also used to compact fresh concrete (i.e., used for so‑called consolidating operation). In the following description, the extension direction of the operation rod 4 is termed a front-rear direction, and the extension direction of a leveler 162 of the leveler unit 16 is termed a right-left direction.

### Configuration of Operation Rod 4

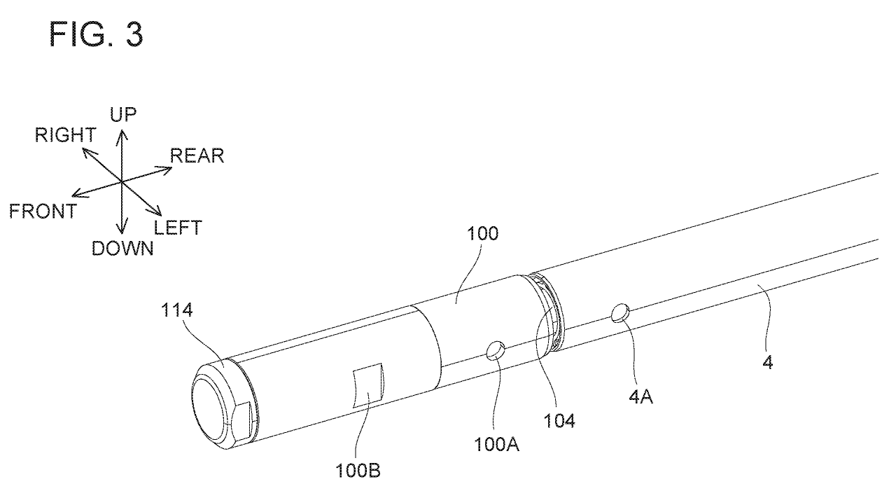

As illustrated in FIG. 2, the operation rod 4 has a hollow-pipe shape and extends linearly. The operation rod 4 is constituted of aluminum. As illustrated in FIG. 3, a through hole 4A is formed in a front end portion of the operation rod 4.

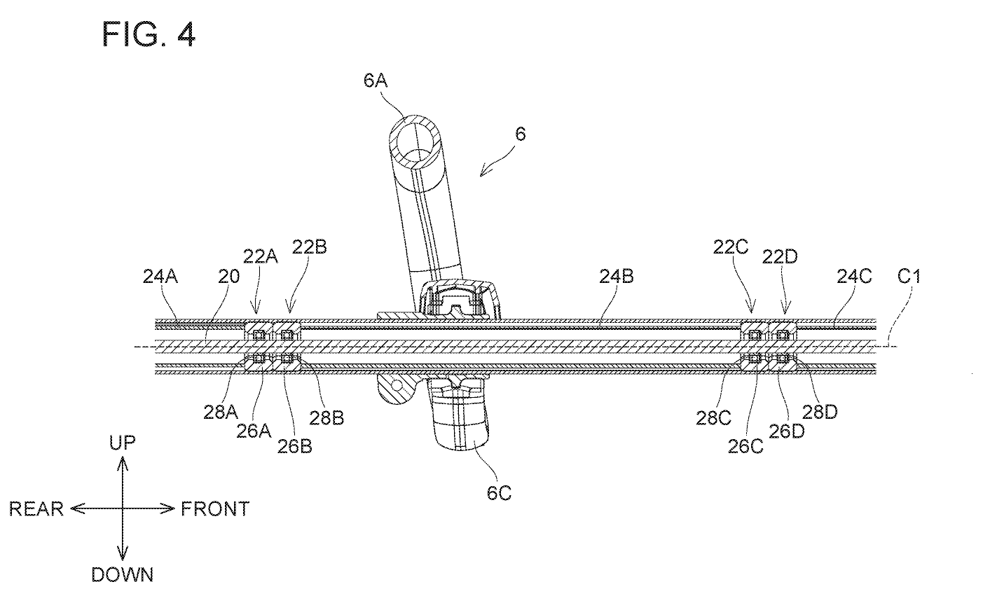

As illustrated in FIG. 2, a metal drive shaft 20, a plurality of bearing units 22A to 22F, and a plurality of liners 24A to 24E are located within the operation rod 4. The drive shaft 20 extends along an axial direction C1. The axial direction C1 is parallel to the front-rear direction. Two bearing units 22A, 22B are adjacent to each other. Two bearing units 22C, 22D are also adjacent to each other. The two bearing units 22A, 22B, the two bearing units 22C, 22D, the bearing unit 22E, and the bearing unit 22F are spaced at equal intervals. As illustrated in FIG. 4, the bearing unit 22A comprises an elastic member 26A and a bearing 28A located radially inward of the elastic member 26A. As illustrated in FIG. 2, the bearing units 22B, 22C, 22D, 22E, and 22F comprise elastic members 26B, 26C, 26D, 26E, and 26F and bearings 28B, 28C, 28D, 28E, and 28F, respectively.

The plurality of liners 24A to 24E is constituted of resin. As illustrated in FIG. 4, the liners 24A to 24E each comprise a cylindrical portion located between the outer surface of the drive shaft 20 and the inner surface of the operation rod 4 and a contact portion that projects radially from the outer surface of the cylindrical portion and contacts the inner surface of the operation rod 4. As illustrated in FIG. 2, the liner 24A is located rearward of the bearing unit 22A, and the liner 24E is located forward of the bearing unit 22F. The liner 24B is located between the bearing unit 22B and the bearing unit 22C. The liner 24C is located between the bearing unit 22D and the bearing unit 22E. The liner 24D is located between the bearing unit 22E and the bearing unit 22F. The liners 24A to 24E define positions of the bearing units 22A to 22F in the front-rear direction (i.e., the axial direction C1).

### Configuration of Loop Handle 6

The loop handle 6 is fixed to the operation rod 4 between the bearing unit 22B and the bearing unit 22C. As illustrated in FIG. 1, the loop handle 6 comprises an upwardly projecting portion 6A, a right downwardly projecting portion 6B, and a left downwardly projecting portion 6C. The upwardly projecting portion 6A forms an upper portion of the loop handle 6 and is shaped to upwardly project from the operation rod 4. The right downwardly projecting portion 6B forms a lower right portion of the loop handle 6 and is shaped to downwardly project from the operation rod 4. The left downwardly projecting portion 6C forms a lower left portion of the loop handle 6 and is shaped to downwardly project from the operation rod 4. As illustrated in FIG. 2, vibration-damping rubber 7 is located at the connection between the loop handle 6 and the operation rod 4.

### Configuration of Housing 8

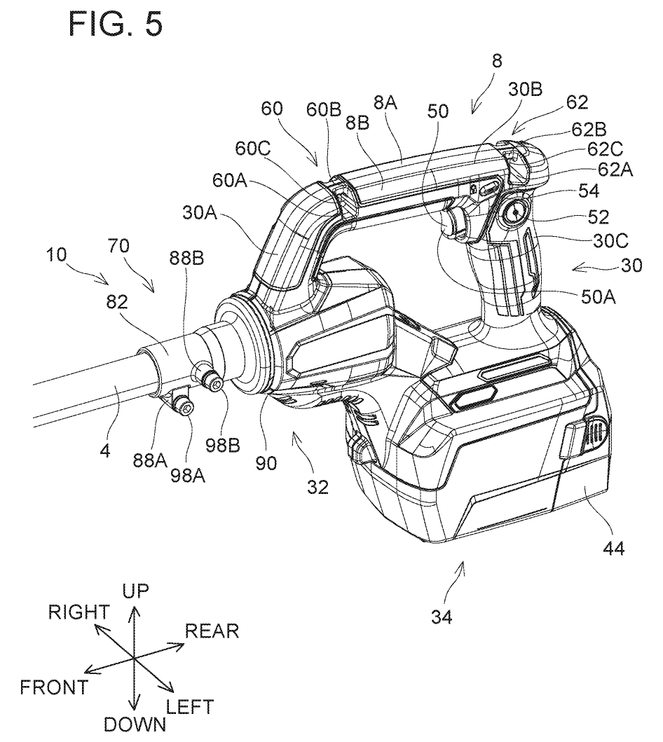

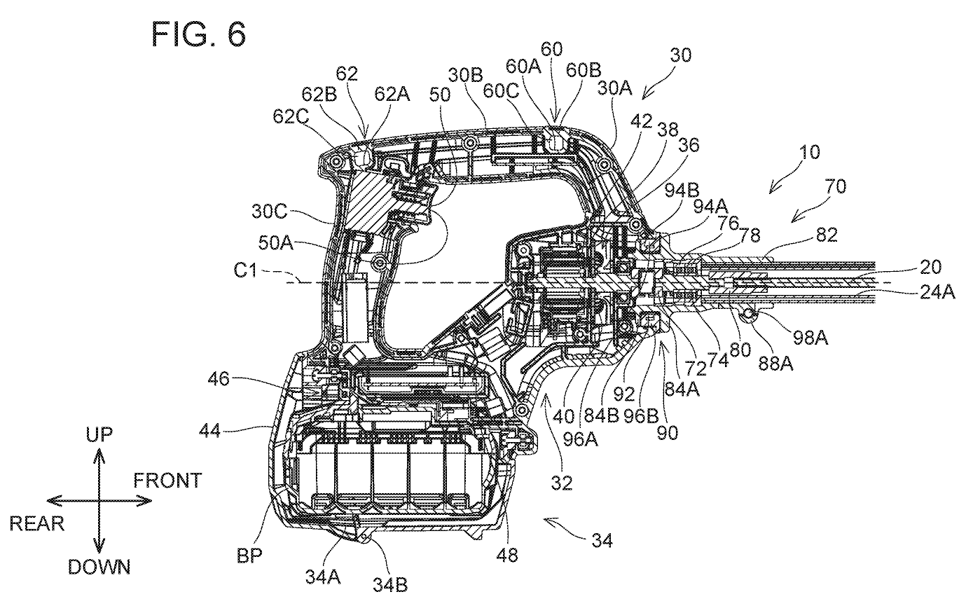

As illustrated in FIG. 5, the housing 8 is mounted to the rear end of the operation rod 4. The housing 8 comprises a right housing 8A and a left housing 8B. The housing 8 further comprises a grip unit 30, a motor accommodating portion 32, and a battery case 34. The motor accommodating portion 32 is located in a front portion of the housing 8. As illustrated in FIG. 6, a motor 36 is accommodated in the motor accommodating portion 32. The motor 36 is a DC brushless motor. The motor 36 comprises a motor shaft 38, a rotor 40, and a stator 42. The front end of the motor shaft 38 is coupled to the rear connector 10.

The grip unit 30 comprises a front grip 30A, an upper grip 30B, and a rear grip 30C. The front grip 30A extends upward and rearward from an upper portion of the motor accommodating portion 32. The upper grip 30B extends rearward from the upper end of the front grip 30A. The rear grip 30C extends downward from the rear end of the upper grip 30B.

The battery case 34 is located in a lower portion of the housing 8. An opening 34A is formed in a rear portion of the battery case 34. A battery cover 44 is located in the rear portion of the battery case 34. The battery cover 44 is configured to open and close the opening 34A. The battery cover 44 is attached to the battery case 34 such that the battery cover 44 is pivotable about a hinge 34B located on a lower surface of rear end portion of the battery case 34. A battery mounting portion 46 is located within the battery case 34. The battery mounting portion 46 is configured to allow a battery pack BP to be detachably attached thereto. When the battery cover 44 is open, the battery pack BP can be attached to or detached from the battery mounting portion 46 by sliding the battery pack BP in the front-rear direction. The battery pack BP comprises secondary battery cells such as lithium-ion battery cells. The rated voltage of the battery pack BP is in the range of 18 V to 40 V, although this is merely an example. The rated voltage of the battery pack BP is 18 V, 36V, or 40V, although this is merely an example. The weight of the screed 2 with the battery pack BP attached thereto is in the range of 5.0 kg to 6.0 kg. Within the housing 8, a control board 48 is located above the battery mounting portion 46. The control board 48 extends in the front-rear direction and the right-left direction. In a modification, the rated voltage of the battery pack BP may be greater than 40 V.

As illustrated in FIG. 5, a trigger switch 50 is located in an upper front portion of the rear grip 30C, and a lock-on button 52 is located in an upper left portion of the rear grip 30C. In response to the trigger switch 50 being pulled by a user, the motor 36 starts being driven. When the lock-on button 52 is pushed while the user is pulling the trigger switch 50, the motor 36 continues to be driven even if the user releases the trigger switch 50. When the user pulls the trigger switch 50 while the motor 36 is continuously being driven, the continuous driving of the motor 36 is terminated. A lock button 54 is located in a rear portion of the upper grip 30B. The lock button 54 projects rightward and leftward from the upper grip 30B. Pushing the lock button 54 rightward prohibits the pulling on the trigger switch 50, while pushing the lock button 54 leftward permits the pulling on the trigger switch 50.

A front mounting portion 60 and a rear mounting portion 62 are located on the upper grip 30B, which is located in an upper portion of the grip unit 30. The front mounting portion 60 and the rear mounting portion 62 are arranged in this order from the front toward the rear. The front mounting portion 60 is located in a front portion of the upper grip 30B. The front mounting portion 60 is located forward of the center of the upper grip 30B in the front-rear direction. As illustrated in FIG. 6, the front mounting portion 60 is located forward of the battery pack BP. Further, the front mounting portion 60 is located rearward of the front end of the motor 36 and forward of the rear end of the motor 36. The rear mounting portion 62 is located in a rear portion of the upper grip 30B. The rear mounting portion 62 is located rearward of the center of the upper grip 30B in the front-rear direction. The rear mounting portion 62 is located rearward of the front end of the battery pack BP and forward of the rear end of the battery pack BP. Further, the rear mounting portion 62 is located rearward of the motor 36. Moreover, the rear mounting portion 62 is located rearward of an operation surface 50A of the trigger switch 50. The operation surface 50A of the trigger switch 50 is the front surface of the trigger switch 50. As illustrated in FIG. 5, the rear mounting portion 62 is located rearward of the lock button 54. Further, the rear mounting portion 62 is located above the lock-on button 52.

The front mounting portion 60 comprises a front recess 60A, a front connection wall 60B, and a front mounting hole 60C. The front recess 60A is recessed downward from the upper surface of the upper grip 30B. The front connection wall 60B connects the front surface of the front recess 60A to the rear surface thereof over the front recess 60A. The front connection wall 60B extends along a central portion of the front recess 60A in the right-left direction. The width of the front connection wall 60B in the right-left direction is less than the width of the front recess 60A in the right-left direction. The upper surface of the front connection wall 60B is flush with the upper surface of the upper grip 30B. That is, the front mounting portion 60 does not project from the upper surface of the upper grip 30B. The front mounting hole 60C is defined by the front recess 60A and the front connection wall 60B. The front mounting hole 60C is located below the front connection wall 60B. The front mounting hole 60C penetrates the upper grip 30B in the right-left direction.

The rear mounting portion 62 comprises a rear recess 62A, a rear connection wall 62B, and a rear mounting hole 62C. The rear recess 62A is recessed downward from the upper surface of the upper grip 30B. The rear connection wall 62B connects the front surface of the rear recess 62A to the rear surface thereof over the rear recess 62A. The rear connection wall 62B extends along a central portion of the rear recess 62A in the right-left direction. The width of the rear connection wall 62B in the right-left direction is less than the width of the rear recess 62A in the right-left direction. The upper surface of the rear connection wall 62B is flush with the upper surface of the upper grip 30B. That is, the rear mounting portion 62 does not project from the upper surface of the upper grip 30B. The rear mounting hole 62C is defined by the rear recess 62A and the rear connection wall 62B. The rear mounting hole 62C is located below the rear connection wall 62B. The rear mounting hole 62C penetrates the upper grip 30B in the right-left direction.

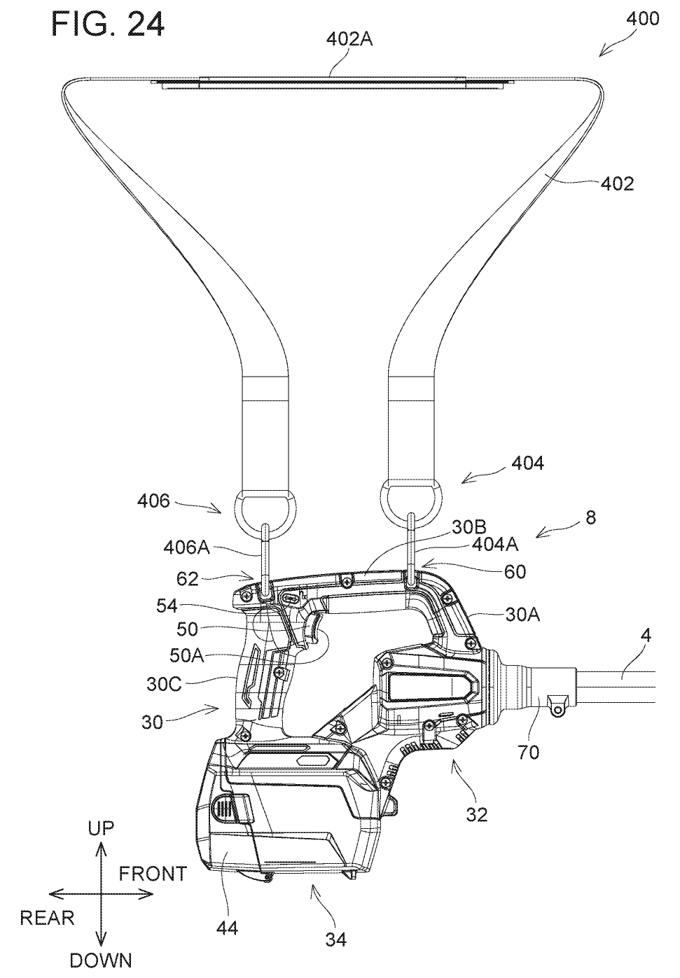

As illustrated in FIG. 24, a shoulder strap 400 can be detachably attached to the housing 8. The shoulder strap 400 comprises a strap portion 402 on which a pad 402A is attached, a first strap-side mounting portion 404 located at one end of the strap portion 402, and a second strap-side mounting portion 406 located at the other end of the strap portion 402. The first strap-side mounting portion 404 comprises a connector 404A configured to be detachably attached to the front mounting portion 60 or the rear mounting portion 62. The second strap-side mounting portion 406 comprises a connector 406A configured to be detachably attached to the front mounting portion 60 or the rear mounting portion 62. The connectors 404A, 406A are, for example, carabiners. In FIG. 24, the connector 404A is illustrated as being attached to the front mounting portion 60 and the connector 406A is illustrated as being attached to the rear mounting portion 62. With this configuration, the user can place the shoulder strap 400 over the shoulder to carry the screed 2. Further, the shoulder strap 400 in the state illustrated in FIG. 24 can be hung on a hook mounted on a wall to store the screed 2.

Further, the connector 404A can be attached to the front mounting portion 60 or the rear mounting portion 62 and the other connector 406A can be attached to, for example, a hook mounted on a structure to prevent the screed 2 from falling.

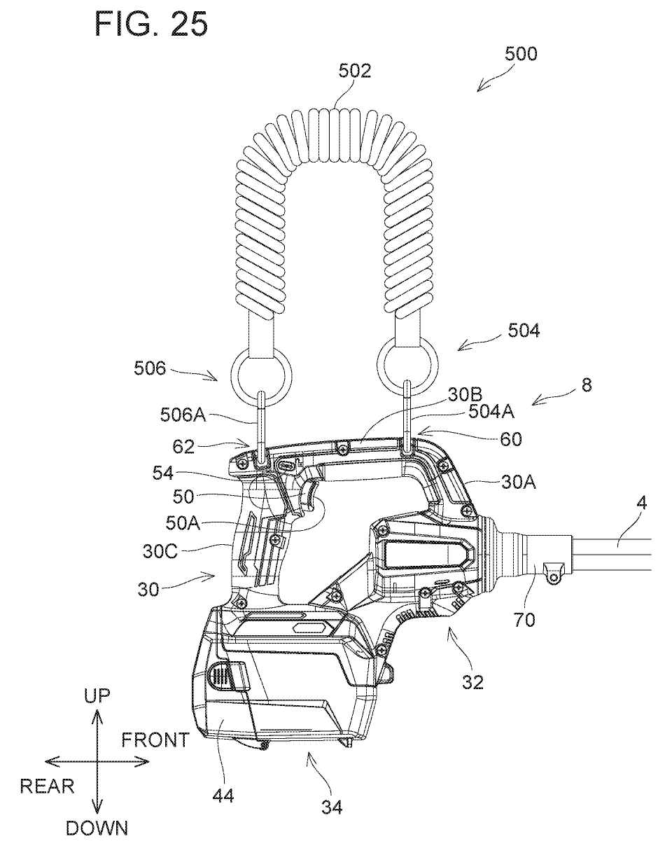

As illustrated in FIG. 25, a stretchable tether strap 500 can be detachably attached to the housing 8. The tether strap 500 comprises a stretchable cord portion 502, a first strap-side mounting portion 504 located at one end of the cord portion 502, and a second strap-side mounting portion 506 located at the other end of the cord portion 502. The first strap-side mounting portion 504 comprises a connector 504A configured to be detachably attached to the front mounting portion 60 or the rear mounting portion 62. The second strap-side mounting portion 506 comprises a connector 506A configured to be detachably attached to the front mounting portion 60 or the rear mounting portion 62. The connectors 504A, 506A are, for example, carabiners. In FIG. 25, the connector 504A is illustrated as being attached to the front mounting portion 60 and the connector 506A is illustrated as being attached to the rear mounting portion 62. With this configuration, the screed 2 can be used with the cord portion 502 wound around a structure, which prevents the screed 2 from falling even when the user releases the screed 2. Further, the screed 2 can be stored with the cord portion 502 of the tether strap 500 in the state illustrated in FIG. 25 wound around a structure, which prevents the screed 2 from falling during storage.

Further, the connector 504A can be attached to the front mounting portion 60 or the rear mounting portion 62 and the other connector 506A can be attached to, for example, a hook mounted on a structure to prevent the screed 2 from falling.

### Configuration of Rear Connector 10

The rear connector 10 detachably couples the operation rod 4 to the housing 8. As illustrated in FIG. 6, the rear connector 10 comprises a retainer 70, a coupling 72, a spindle 74, bearings 76, 78, and a joint 80.

The retainer 70 comprises a cylinder 82, a front flange 84A, a rear flange 84B, fastening portions 88A, 88B (see FIG. 5), and an elastic member 90. The cylinder 82 extends along the front-rear direction. The front flange 84A and the rear flange 84B project radially outward from the outer surface of a rear end portion of the cylinder 82. The front flange 84A and the rear flange 84B are spaced from each other in the front-rear direction.

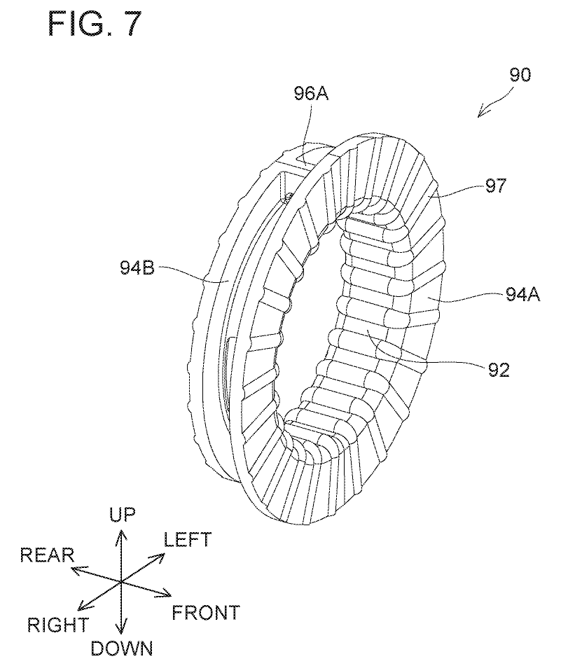

The elastic member 90 is located between the front flange 84A and the rear flange 84B. As illustrated in FIG. 7, the elastic member 90 comprises a cylinder 92, a front flange 94A, a rear flange 94B, an upper connection portion 96A, and a lower connection portion 96B. The front flange 94A is located on a front end portion of the cylinder 92. The rear flange 94B is located on a rear end portion of the cylinder 92. The upper connection portion 96A connects the front flange 94A to the rear flange 94B in a front portion of the elastic member 90. The lower connection portion 96B connects the front flange 94A to the rear flange 94B in a lower portion of the elastic member 90. The elastic member 90 further comprises a plurality of projections 97. The projections 97 are arranged at equal intervals in a circumferential direction. The projections 97 project from the front surface of the front flange 94A, the inner surface of the cylinder 92, and the rear surface of the rear flange 94B. The projections 97 of the elastic member 90 contact the cylinder 82 of the retainer 70, the front flange 84A, and the rear flange 84B. The retainer 70 is attached to the housing 8 via the elastic member 90. The elastic member 90 damps vibrations transmitted from the operation rod 4 to the housing 8.

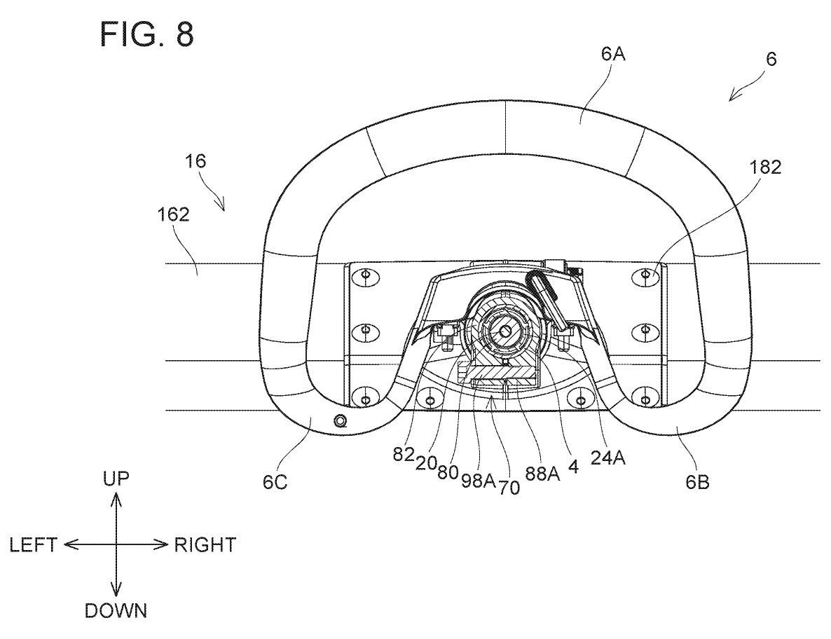

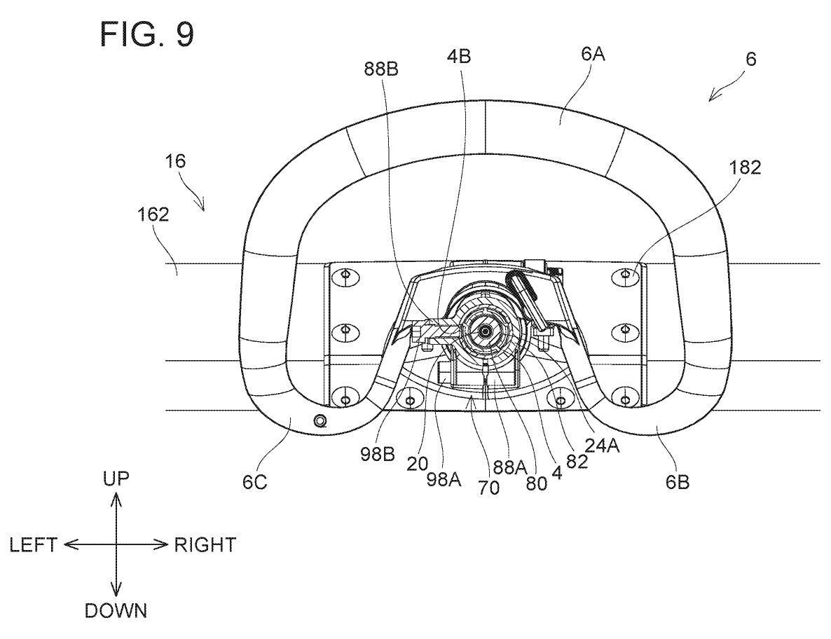

As illustrated in FIG. 5, the fastening portions 88A, 88B are located near a front end portion of the cylinder 82. As illustrated in FIG. 8, a slit is formed in the fastening portion 88A, and the slit penetrates the fastening portion 88A in an up-down direction and extends in the front-rear direction. When a fastener 98A is fastened, the width of the slit in the right-left direction is thereby narrowed. Thus, the diameter of the cylinder 82 is decreased. As a result, the rear end portion of the operation rod 4 is held (clamped) by the cylinder 82. As illustrated in FIG. 9, the distal end (right end) of a fastener 98B in the fastening portion 88B is located in a through hole 4B of the operation rod 4. This limits rotation and movement of the operation rod 4.

As illustrated in FIG. 6, a front end portion of the motor shaft 38 of the motor 36 is coupled to a rear end portion of the coupling 72. A rear end portion of the spindle 74 is coupled to a front end portion of the coupling 72. The bearings 76, 78 support the spindle 74 such that the spindle 74 is rotatable.

A front end portion of the spindle 74 is coupled to a rear end portion of the joint 80. A rear end portion of the drive shaft 20 is coupled to a front end portion of the joint 80. Rotation of the motor shaft 38 is transmitted to the drive shaft 20 via the coupling 72, the spindle 74, and the joint 80.

### Configuration of Eccentric Member Accommodating Part 14

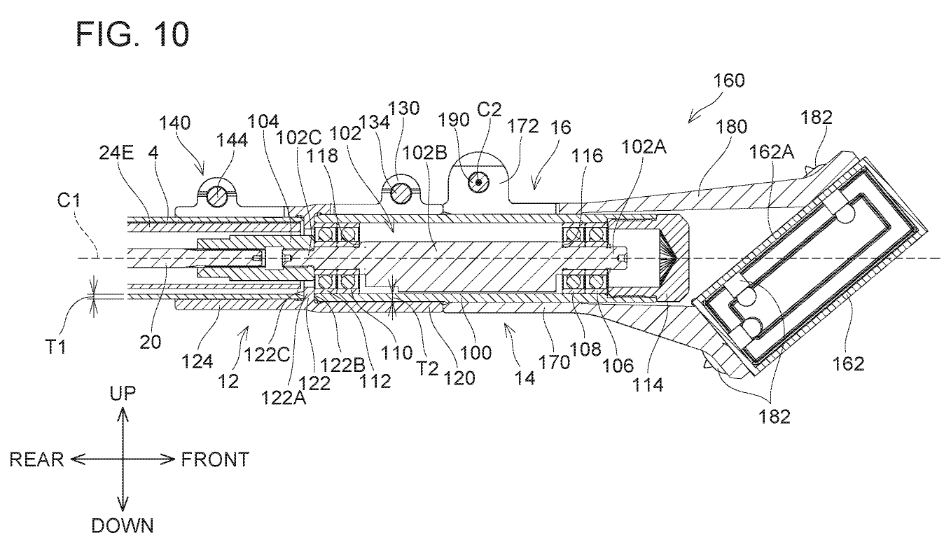

As illustrated in FIG. 10, the eccentric member accommodating part 14 is located on a front portion of the operation rod 4. The eccentric member accommodating part 14 comprises a cylinder 100, an eccentric member 102, a joint 104, a plurality of bearings 106, 108, 110, 112, and a cap 114. The cylinder 100 is constituted of iron, although this is merely an example. The cylinder 100 extends along the front-rear direction. The inner diameter of the cylinder 100 is substantially the same as the inner diameter of the operation rod 4. The outer diameter of the cylinder 100 is slightly greater than the outer diameter of the operation rod 4. That is, thickness T2 of the cylinder 100 is greater than thickness T1 of the operation rod 4. As illustrated in FIG. 3, a through hole 100A and a recess 100B are formed in the cylinder 100. The cap 114 is fixed to a front end portion of the cylinder 100.

As illustrated in FIG. 10, the eccentric member 102 comprises a front shaft 102A, an intermediate shaft 102B, and a rear shaft 102C.

The front shaft 102A extends forward from the intermediate shaft 102B. The front shaft 102A is rotatably supported by the bearings 106, 108. A front stepped portion 116 is formed at the boundary between the front shaft 102A and the intermediate shaft 102B. The bearings 106, 108 are adjacent to each other between the front stepped portion 116 and the cap 114. The front surface of the bearing 106 contacts a rear end portion of the cap 114. The rear surface of the bearing 108 contacts the front stepped portion 116. The bearings 106, 108 are positioned in the front-rear direction by the front stepped portion 116 and the cap 114.

The rear shaft 102C extends rearward from the intermediate shaft 102B. The rear shaft 102C is rotatably supported by the bearings 110, 112. A rear stepped portion 118 is formed at the boundary between the rear shaft 102C and the intermediate shaft 102B.

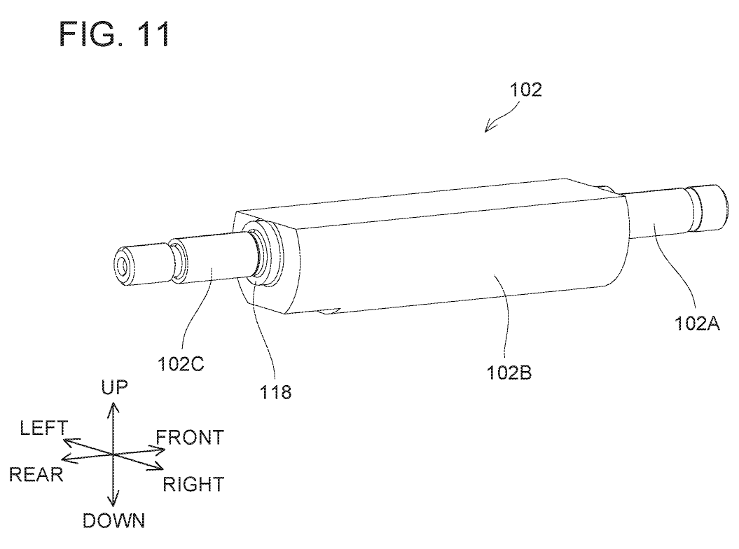

As illustrated in FIG. 11, in the intermediate shaft 102B, an upper portion of its cylindrical shape is cut off and its lower rear portion is notched.

### Configuration of Front Connector 12

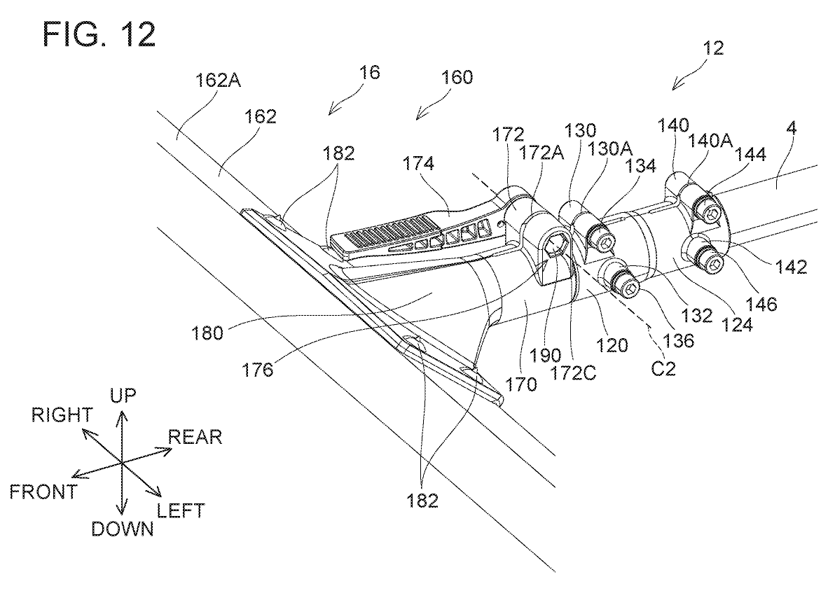

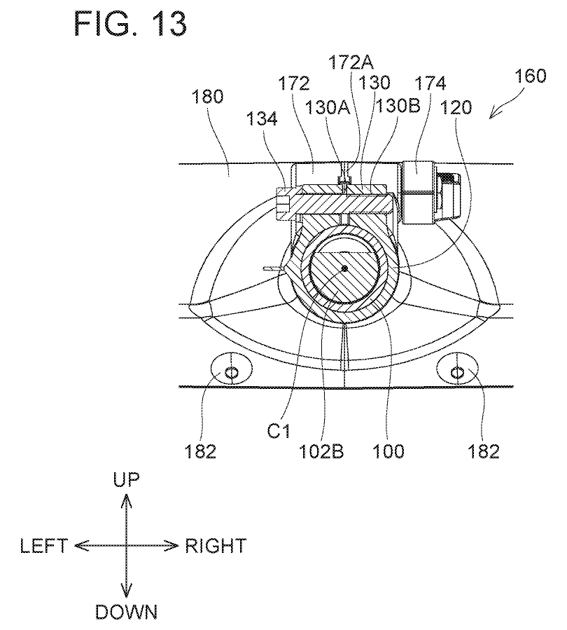

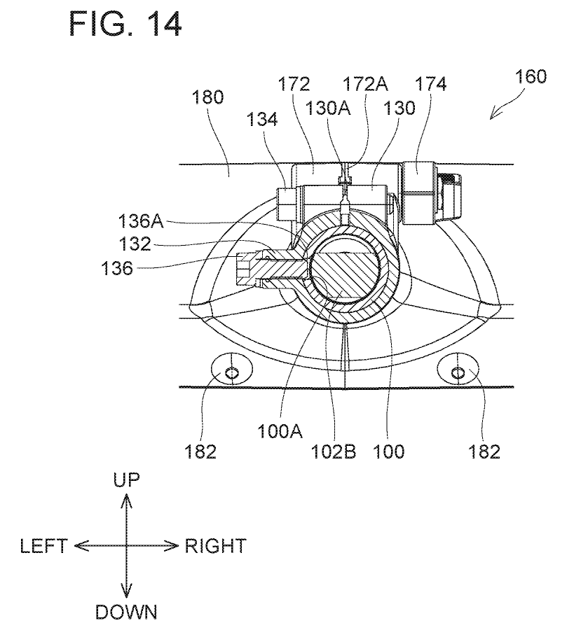

As illustrated in FIG. 10, the front connector 12 comprises a front clamp portion 120, an intermediate cylinder 122, and a rear clamp portion 124. The front clamp portion 120 and the rear clamp portion 124 each have a cylindrical shape. The front clamp portion 120 extends forward from the front end of the intermediate cylinder 122. The front clamp portion 120 covers the outer surface of a rear end portion of the cylinder 100 of the eccentric member accommodating part 14. The inner diameter of the front clamp portion 120 is slightly greater than the outer diameter of the cylinder 100. As illustrated in FIG. 12, the front clamp portion 120 comprises an upper fastening portion 130 and a lower fastening portion 132. The upper fastening portion 130 projects from the outer surface of the front clamp portion 120. A slit 130A is formed in a central portion of the upper fastening portion 130 in the right-left direction. The slit 130A penetrates the upper fastening portion 130 in the up-down direction and extends in the front-rear direction. A fastener 134 is fastened to the upper fastening portion 130. As illustrated in FIG. 13, the upper fastening portion 130 comprises a screw portion 130B in a portion rightward of the slit 130A. When the fastener 134 is fastened to the upper fastening portion 130, the width of the slit 130A is thereby narrowed. Thus, the diameter of the front clamp portion 120 is decreased. As a result, the cylinder 100 is held (clamped) by the front clamp portion 120. As illustrated in FIG. 14, a fastener 136 is fastened to the lower fastening portion 132. A right end portion 136A of the fastener 136 is located within the through hole 100A of the cylinder 100 of the eccentric member accommodating part 14. This limits rotation and movement of the cylinder 100.

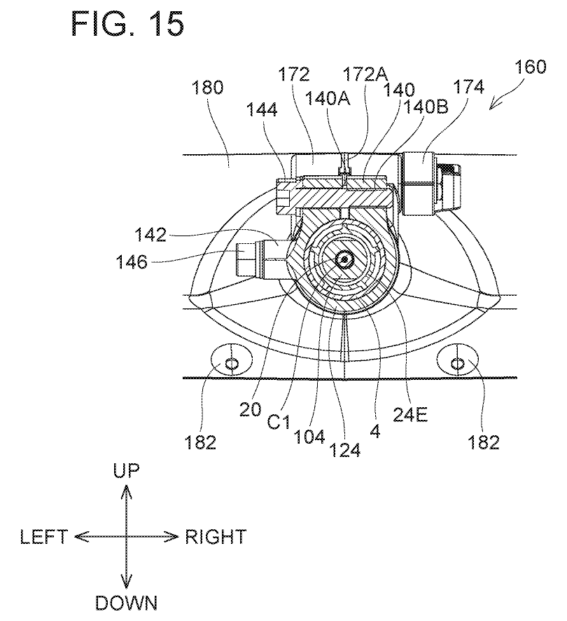

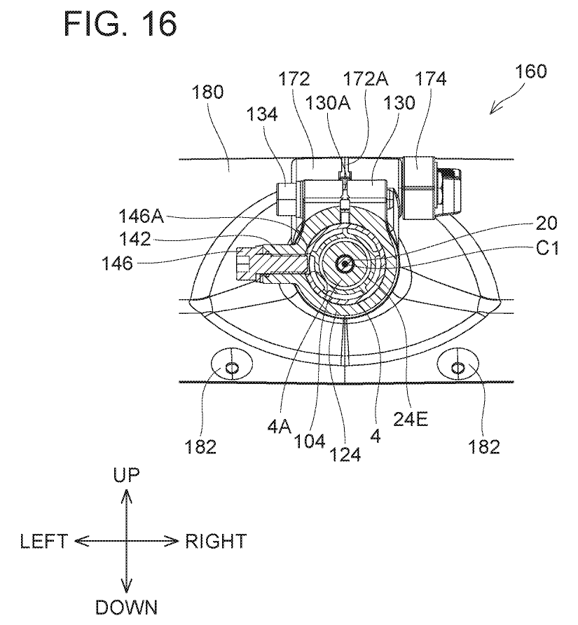

As illustrated in FIG. 10, the rear clamp portion 124 extends rearward from the rear end of the intermediate cylinder 122. The rear clamp portion 124 covers the outer surface of the front end portion of the operation rod 4. The inner diameter of the rear clamp portion 124 is slightly greater than the outer diameter of the operation rod 4. The outer diameter of the rear clamp portion 124 is slightly less than the outer diameter of the front clamp portion 120. As illustrated in FIG. 12, the rear clamp portion 124 comprises an upper fastening portion 140 and a lower fastening portion 142. The upper fastening portion 140 projects from the outer surface of the rear clamp portion 124. A slit 140A is formed in a central portion of the upper fastening portion 140 in the right-left direction. The slit 140A penetrates the upper fastening portion 140 in the up-down direction and extends in the front-rear direction. A fastener 144 is fastened to the upper fastening portion 140. As illustrated in FIG. 15, the upper fastening portion 140 comprises a screw portion 140B in a portion rightward of the slit 140A. When the fastener 144 is fastened to the upper fastening portion 140, the width of the slit 140A is thereby narrowed. Thus, the diameter of the rear clamp portion 124 is decreased. As a result, the operation rod 4 is held (clamped) by the rear clamp portion 124. As illustrated in FIG. 16, a fastener 146 is fastened to the lower fastening portion 142. A right end portion 146A of the fastener 146 is located within the through hole 4A of the operation rod 4. This limits rotation and movement of the operation rod 4.

As illustrated in FIG. 10, the outer diameter of the intermediate cylinder 122 gradually increases toward the front. The intermediate cylinder 122 comprises a flange 122A projecting radially inward from the inner surface of the intermediate cylinder 122. The flange 122A is located between the operation rod 4 and the cylinder 100 of the eccentric member accommodating part 14 in the front-rear direction. The inner diameter of the flange 122A is less than the inner diameter of the operation rod 4, the inner diameter of the cylinder 100, and the outer diameter of the bearing 112. The inner diameter of the flange 122A is greater than the inner diameter of the bearing 112 and the outer diameter of a front end portion of the joint 104. The rear end of the cylinder 100 contacts a front surface 122B of the flange 122A. The rear end of the bearing 112 contacts the front surface 122B of the flange 122A and the joint 104. The front end of the operation rod 4 contacts a rear surface 122C of the flange 122A.

The bearings 110, 112 are adjacent to each other between the rear stepped portion 118 of the eccentric member 102 and the flange 122A. The front surface of the bearing 110 contacts the rear stepped portion 118. The rear surface of the bearing 112 contacts the flange 122A. The bearings 110, 112 are positioned in the front-rear direction by the rear stepped portion 118 and the flange 122A.

### Configuration of Leveler Unit 16

As illustrated in FIG. 12, the leveler unit 16 comprises a lever unit 160 and a leveler 162. As illustrated in FIG. 1, the leveler 162 has a substantially cuboid shape having its longitudinal direction along the right-left direction. Hereinafter, a direction that is along an upper surface 162A of the leveler 162 and perpendicular to the longitudinal direction is termed a transverse direction. Further, a direction perpendicular to the longitudinal direction and the transverse direction is termed a thickness direction. The size of the leveler 162 in the longitudinal direction is in the range of 800 mm to 3000 mm, although this is merely an example. The size of the leveler 162 in the longitudinal direction is, for example, 900 mm, 1400 mm, or 1800 mm. The size of the leveler 162 in the transverse direction is in the range of 60 mm to 80 mm, although this is merely an example. The size of the leveler 162 in the transverse direction is, for example, 70 mm. The size of the leveler 162 in the thickness direction is in the range of 10 mm to 40 mm, although this is merely an example. The size of the leveler 162 in the thickness direction is, for example, 30 mm.

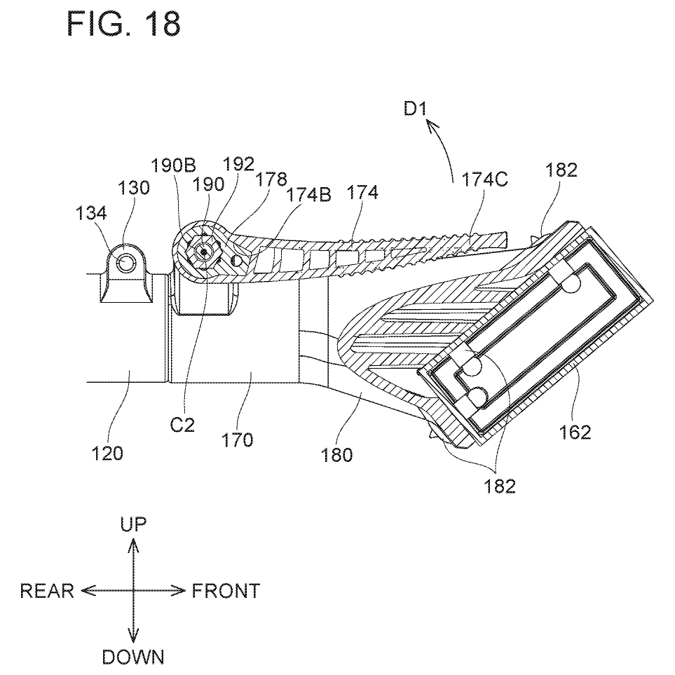

As illustrated in FIG. 12, the lever unit 160 comprises a cylinder 170, a projection 172, a lever 174, a fastening unit 176, a sleeve 178 (see FIG. 18), and a fixing portion 180. The fixing portion 180 is located frontward of the cylinder 170. The leveler 162 is fixed to the fixing portion 180 with a plurality of rivets 182.

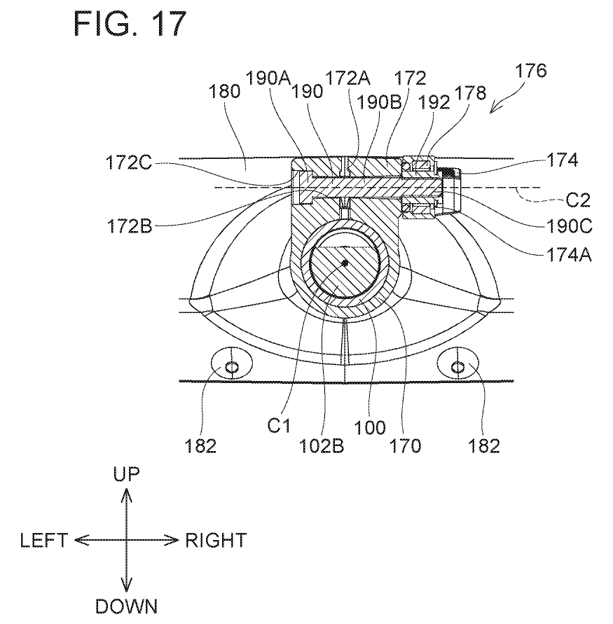

As illustrated in FIG. 10, the outer diameter and inner diameter of the cylinder 170 are the same as the outer diameter and the inner diameter of the front clamp portion 120 of the front connector 12, respectively. The inner diameter of the cylinder 170 is slightly greater than the outer diameter of the cylinder 100 of the eccentric member accommodating part 14. A rear end portion of the cylinder 170 contacts the front end portion of the front clamp portion 120. The projection 172 projects upward from the cylinder 170. As illustrated in FIG. 17, a slit 172A is formed in a central portion of the projection 172 in the right-left direction. The slit 172A penetrates the projection 172 in the up-down direction and extends in the front-rear direction. A through hole 172B is formed in the projection 172, and the through hole 172B penetrates the projection 172 in the right-left direction. A recess 172C is formed in the left surface of the projection 172, and the recess 172C is recessed rightward from the left surface of the projection 172.

The lever 174 has its longitudinal direction along the front-rear direction. A through hole 174A is formed in a rear portion of the lever 174, and the through hole 174A penetrates the lever 174 in the right-left direction. As illustrated in FIG. 18, the lever 174 comprises a sleeve accommodating portion 174B for accommodating the sleeve 178.

As illustrated in FIG. 17, the fastening unit 176 comprises a bolt 190 and a nut 192. A head 190A of the bolt 190 is located in the recess 172C. A distal end portion 190C of an under-head portion 190B of the bolt 190 projects rightward from the right surface of the projection 172. The distal end portion 190C is screwed into the nut 192. As illustrated in FIG. 18, the nut 192 is engaged with the sleeve 178.

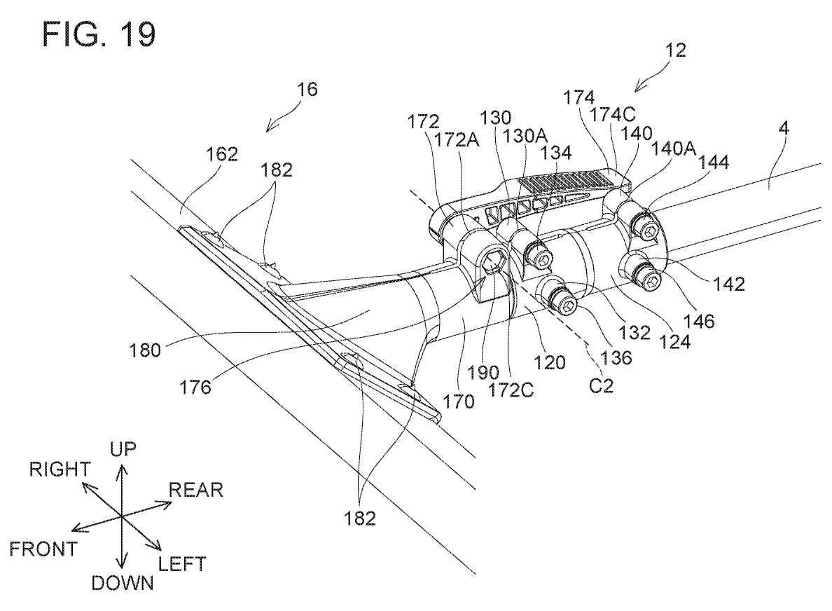

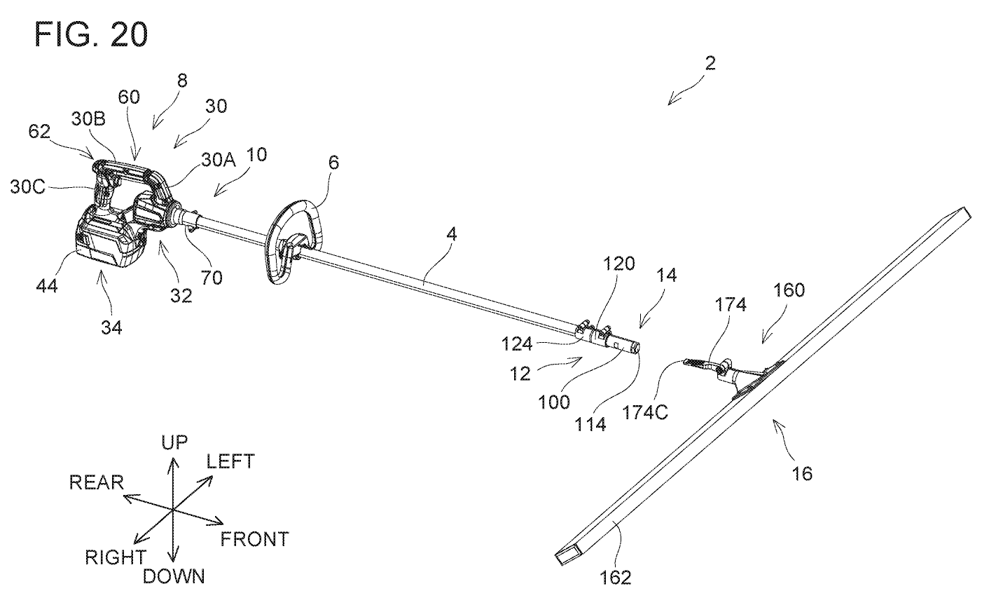

The lever 174 is pivotable about a center axis C2 with respect to the projection 172. The lever 174 is engaged with the nut 192 of the fastening unit 176 via the sleeve 178. Thus, when the lever 174 pivots, the nut 192 rotates. In this embodiment, when a distal end portion 174C of the lever 174 is positioned forward of the center axis C2 as illustrated in FIG. 18, the cylinder 100 of the eccentric member accommodating part 14 is clamped by the lever unit 160. Hereinafter, this position is termed “clamp position”. When the lever 174 is operated in a direction D1 (counterclockwise direction in FIG. 18), the clamping force exerted by the nut 192 is reduced. Then, when the lever 174 is operated until the distal end portion 174C is positioned rearward of the center axis C2 as illustrated in FIG. 19, the width of the slit 172A of the projection 172 in the right-left direction is widened by the lever unit 160. Hereinafter, this position is termed “unclamp position”. By operating the lever 174, the diameter of the cylinder 170 is increased. As a result, the eccentric member accommodating part 14 is brought into a state where it is not clamped by the lever unit 160. In this state, the user can detach the leveler unit 16 from the front connector 12 as illustrated in FIG. 20.

In one or more embodiments, the screed 2 comprises: the motor 36; the housing 8 accommodating the motor 36, wherein the housing 8 comprises the battery mounting portion 46 (an example of “first mounting portion”) to which the battery pack BP is detachably attached; the tubular operation rod 4 constituted of metal, wherein the operation rod 4 extends from the housing 8 toward the front (an example of “first side”) in the front-rear direction (an example of “specific direction”) and accommodates the drive shaft 20 connected to the motor 36; the eccentric member accommodating part 14 disposed forward of the operation rod 4 in the front-rear direction, wherein the eccentric member accommodating part 14 accommodates the eccentric member 102 connected to the drive shaft 20 and the plurality of bearings 106, 108, 110, 112 that support the eccentric member 102 such that the eccentric member 102 is rotatable; the front connector 12 (an example of “connector”) connecting the operation rod 4 to the eccentric member accommodating part 14 in the front-rear direction; and the leveler 162 connected to the eccentric member accommodating part 14.

In the configuration above, the operation rod 4 accommodating the drive shaft 20 and the eccentric member accommodating part 14 accommodating the eccentric member 102 are separate components. Therefore, the thickness of the operation rod 4 can be reduced compared to the thickness of the eccentric member accommodating part 14. This allows for a weight reduction of the operation rod 4, thus allows for a weight reduction of the screed 2.

In one or more embodiments, the screed 2 further comprises the lever unit 160 (an example of “second mounting portion”) coupled to the leveler 162, wherein the eccentric member accommodating part 14 is configured to be detachably attached to the lever unit 160. The plurality of bearings 106, 108, 110, 112 include the bearings 110, 112 (an example of “at least one first bearing”) and the bearings 106, 108 (an example of “at least one second bearing”). The bearings 110, 112 are disposed in the rear end portion (an example of “first end portion”) of the eccentric member accommodating part 14, and the rear end portion is a portion of the eccentric member accommodating part 14 located on the rear side (an example of “second side”) in the front-rear direction. The bearings 106, 108 are disposed in the front end portion (an example of “second end portion”) of the eccentric member accommodating part 14 and the front end portion is a portion of the eccentric member accommodating part 14 on the first side. The front connector 12 comprises the front clamp portion 120 (an example of “first cover”) configured to cover the rear end portion of the eccentric member accommodating part 14. The lever unit 160 comprises the cylinder 170 (an example of “second cover”) configured to cover the front end portion of the eccentric member accommodating part 14.

According to the above configuration, portions of the eccentric member accommodating part 14 where the bearings 106, 108, 110, 112 are located are covered by the front clamp portion 120 and the cylinder 170. This allows for a reduction in the thickness of the eccentric member accommodating part 14 compared to a configuration where the portions of the eccentric member accommodating part 14 are not covered by the covers. Accordingly, the configuration above allows for a weight reduction of the screed 2.

In one or more embodiments, the front connector 12 comprises both the rear clamp portion 124 (an example of “first clamp”) configured to clamp the operation rod 4 and the front clamp portion 120 (an example of “second clamp”) configured to clamp the eccentric member accommodating part 14.

The configuration above allows the front connector 12 to easily retain the operation rod 4 and the eccentric member accommodating part 14.

In one or more embodiments, the front connector 12 comprises the flange 122A (an example of “projection”) projecting inward from the outer peripheral portion of the front connector 12. Among the plurality of bearings 106, 108, 110, 112, the bearing 112 (an example of “specific bearing”) positioned at most rearward position in the front-rear direction contacts the flange 122A.

The configuration above allows the bearing 112 to be positioned in the front-rear direction by the flange 122A.

In one or more embodiments, the weight of the screed 2 with the battery pack BP attached to the battery mounting portion 46 is in the range of 5.0 kg to 6.0 kg.

The configuration above improves the operability of the screed 2 for a user.

In one or more embodiments, the size of the screed 2 in the front-rear direction is in the range of 1,000 mm to 2,000 mm. Here, the size of the screed 2 in the front-rear direction means the size from the rear end of the battery case 34 to the front end of the leveler 162.

In one or more embodiments, the size of the leveler 162 in the longitudinal direction is in the range of 800 mm to 3,000 mm.

In one or more embodiments, the motor 36 is a brushless motor.

The configuration above can suppress vibrations induced by the motor 36 compared to the motor 36 being a brushed motor. Further, the configuration above can maintain the rotational speed of the motor 36 constant regardless of the remaining charge of the battery pack BP attached to the battery mounting portion 46.

In one or more embodiments, the screed 2 further comprises: the cylinder 170 (an example of “second mounting portion”) coupled to the leveler 162, wherein the eccentric member accommodating part 14 is configured to be detachably attached to the cylinder 170; and the lever 174 pivotably supported by the cylinder 170. The lever 174 is configured to move between the clamp position (an example of “first position”) where the eccentric member accommodating part 14 is attachable to the cylinder 170 and the unclamp position (an example of “second position”) where the eccentric member accommodating part 14 is not attachable to the cylinder 170.

The configuration above allows the user to attach the eccentric member accommodating part 14 to the cylinder 170 or detach the eccentric member accommodating part 14 from the cylinder 170 by operating the lever 174. Thus, user convenience is improved.

In one or more embodiments, the screed 2 further comprises the loop handle disposed on the operation rod 4.

The configuration above improves the operability of the operation rod 4 for the user.

In one or more embodiments, the operation rod 4 and the leveler 162 are constituted of aluminum.

The configuration above allows for a weight reduction of the operation rod 4 and the leveler 162, thus allows for a weight reduction of the screed 2.

Additional features of the screed disclosed herein are listed below.

### Feature 1

A screed comprising a motor: a housing accommodating the motor; an operation rod extending forward from the housing; and a leveler coupled to the operation rod, wherein the housing comprises a first mounting portion to which a shoulder strap or a tether strap is detachably attached.

### Feature 2

The screed according to the feature 1, wherein the first mounting portion is located in a rear portion of the housing.

### Feature 3

The screed according to the feature 1 or 2, wherein the first mounting portion is located in an upper portion of the housing.

### Feature 4

The screed according to the feature 3, wherein the housing comprises: an upper grip located in the upper portion of the housing and extending in a front-rear direction; and a rear grip extending downward from a rear end of the upper grip, wherein the first mounting portion is located on the upper grip.

### Feature 5

The screed according to the feature 4, further comprising a trigger switch for driving the motor, wherein the trigger switch is located on the rear grip and comprises an operation surface configured to be operated by a user, wherein the first mounting portion is located rearward of the operation surface of the trigger switch.

### Feature 6

The screed according to any of the features 3 to 5, wherein the first mounting portion does not project from an upper surface of the housing.

### Feature 7

The screed according to the feature 1, wherein an end of the shoulder strap or the tether strap is configured to be detachably attached to the first mounting portion, and wherein the screed further comprises a second mounting portion located on the housing and to which another end of the shoulder strap or the tether strap is detachably attached.

### Feature 8

The screed according to the feature 7, wherein the first mounting portion is located in a rear portion of the housing and the second mounting portion is located in a front portion of the housing.

### Feature 9

The screed according to the feature 7 or 8, wherein the first mounting portion and the second mounting portion are located in an upper portion of the housing.

### Feature 10

The screed according to the feature 9, wherein the housing comprises: an upper grip located in the upper portion of the housing; and a rear grip extending downward from a rear end of the upper grip, and wherein the first mounting portion and the second mounting portion are located on the upper grip.

### Feature 11

The screed according to the feature 10, further comprising a trigger switch for driving the motor, wherein the trigger switch is located on the rear grip and comprises an operation surface configured to be operated by a user, wherein the first mounting portion is located rearward of the operation surface of the trigger switch.

### Feature 12

The screed according to any of the features 9 to 11, wherein the first mounting portion and the second mounting portion do not project from an upper surface of the housing.

In one or more embodiments, the screed 2 comprises the motor 36, the housing 8 accommodating the motor 36, the operation rod 4 extending forward from the housing 8, and the leveler 162 coupled to the operation rod 4. The housing 8 comprises the rear mounting portion 62 (an example of “first mounting portion”) to which the shoulder strap 400 or the tether strap 500 is detachably attached.

The configuration above allows the user to place the shoulder strap 400 over the shoulder to carry the screed 2. Further, the screed 2 is prevented from falling by using the tether strap 500. Further, the screed 2 can be stored by using the shoulder strap 400 or the tether strap 500. Thus, user convenience is improved.

In one or more embodiments, the rear mounting portion 62 is located in the rear portion of the housing 8.

The configuration above allows the user to hold the screed 2 in good balance compared to a configuration where the mounting portion is not located in the rear portion of the housing 8.

In one or more embodiments, the rear mounting portion 62 is located in the upper portion of the housing 8.

The user often holds a portion near the rear surface of the housing 8 when using the screed 2. The configuration above prevents the rear mounting portion 62 from interfering with the user.

In one or more embodiments, the housing 8 comprises the upper grip 30B located in the upper portion of the housing 8 and extending in the front-rear direction; and the rear grip 30C extending downward from the rear end of the upper grip 30B. The rear mounting portion 62 is located in the upper grip 30B.

The user often holds the rear grip 30C when using the screed 2. The configuration above prevents the rear mounting portion 62 from interfering with the user.

In one or more embodiments, the screed 2 further comprises the trigger switch 50 for driving the motor 36, wherein the trigger switch 50 is located on the rear grip 30C and comprises the operation surface 50A configured to be operated by the user. The rear mounting portion 62 is located rearward of the operation surface 50A of the trigger switch 50.

The configuration above allows the user to hold the screed 2 in good balance.

In one or more embodiments, the rear mounting portion 62 does not project from the upper surface of the housing 8.

The configuration above prevents the rear mounting portion 62 from being damaged when the screed 2 falls and the upper surface of the housing 8 hits the ground.

In one or more embodiments, an end of the shoulder strap 400 or the tether strap 500 is detachably attached to the rear mounting portion 62. The screed 2 further comprises the front mounting portion 60 (an example of “second mounting portion”) located on the housing 8 and to which the other end of the shoulder strap 400 or the tether strap 500 is detachably attached.

The configuration above allows the user to hold the screed 2 in good balance compared to a configuration where the screed 2 comprises only one mounting portion.

In one or more embodiments, the rear mounting portion 62 is located in the rear portion of the housing 8 and the front mounting portion 60 is located in the front portion of the housing 8.

The configuration allows the user to hold the screed 2 in good balance.

In one or more embodiments, the rear mounting portion 62 and the front mounting portion 60 are located in the upper portion of the housing 8.

The user often holds a portion near the rear surface of the housing 8 when using the screed 2. The configuration above prevents the rear mounting portion 62 and the front mounting portion 60 from interfering with the user.

In one or more embodiments, the housing 8 comprises the upper grip 30B located in the upper portion of the housing 8 and extending in the front-rear direction; and the rear grip 30C extending downward from the rear end of the upper grip 30B. The rear mounting portion 62 and the front mounting portion 60 are located on the upper grip 30B.

The user often holds the rear grip 30C when using the screed 2. The configuration above prevents the rear mounting portion 62 and the front mounting portion 60 from interfering with the user.

In one or more embodiments, the screed 2 further comprises the trigger switch 50 for driving the motor 36, wherein the trigger switch 50 is located on the rear grip 30C and comprises the operation surface 50A configured to be operated by the user. The rear mounting portion 62 is located rearward of the operation surface 50A of the trigger switch 50.

The configuration allows the user to hold the screed 2 in good balance.

In one or more embodiments, the rear mounting portion 62 and the front mounting portion 60 do not project from the upper surface of the housing 8.

The configuration above prevents the rear mounting portion 62 and the front mounting portion 60 from being damaged when the screed 2 falls and the upper surface of the housing 8 hits the ground.

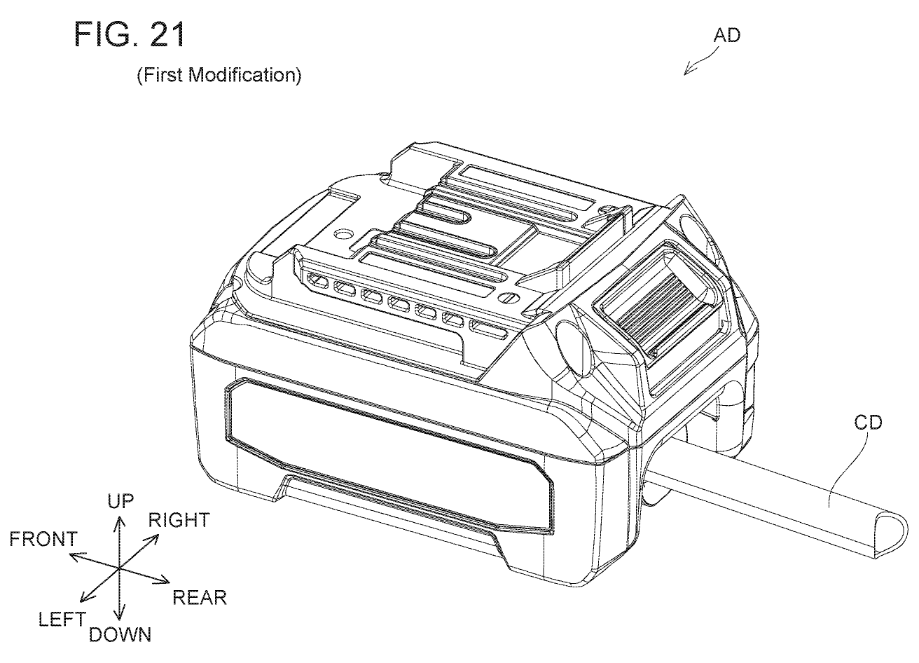

(First Modification) An adapter AD (see FIG. 21) connected to an external supply via a cable may be attached to the battery mounting portion 46. In this modification, the battery case 34 may have a hole through which a cable CD connecting the adapter AD to the external supply passes.

(Second Modification) The front connector 12 may clamp a portion of the cylinder 100 of the eccentric member accommodating part 14 in which no bearings are located. The leveler unit 16 may clamp a portion of the cylinder 100 in which no bearings are located.

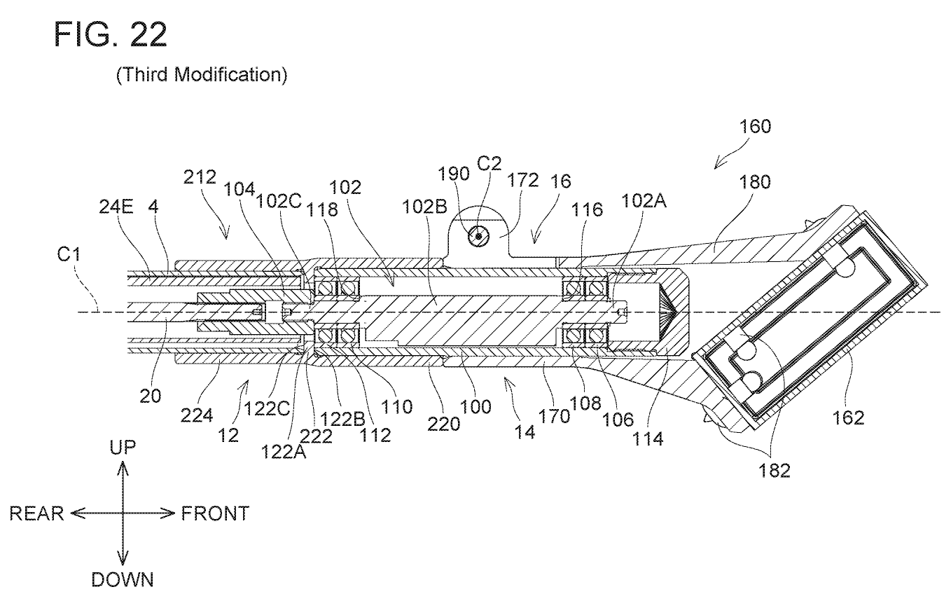

(Third Modification) Referring to FIG. 22, a screed according to a third modification is described. The screed according to the third modification is different from the screed 2 according to the embodiment in the configuration of a front connector 212 and how the operation rod 4 and the eccentric member accommodating part 14 are connected to the front connector 212. Hereinafter, components common to the embodiment and modifications are denoted by the same reference signs, and their description is omitted.

As illustrated in FIG. 22, the front connector 212 comprises a front press-fit portion 220, an intermediate cylinder 222, and a rear press-fit portion 224. The front press-fit portion 220 and the rear press-fit portion 224 each have a cylindrical shape. The front press-fit portion 220 extends forward from the front end of the intermediate cylinder 222. The front press-fit portion 220 covers the outer surface of the rear end portion of the cylinder 100 of the eccentric member accommodating part 14. Before the rear end portion of the cylinder 100 is coupled to the connector 212, the inner diameter of the front press-fit portion 220 is slightly less than the outer diameter of the cylinder 100. The rear end portion of the cylinder 100 and the front press-fit portion 220 are fixed to each other by press-fit.

The rear press-fit portion 224 extends rearward from the rear end of the intermediate cylinder 222. The rear press-fit portion 224 covers the outer surface of the front end portion of the operation rod 4. Before the front end portion of the operation rod 4 is coupled to the connector 212, the inner diameter of the rear press-fit portion 224 is slightly less than the outer diameter of the operation rod 4. The front end portion of the operation rod 4 and the rear press-fit portion 224 are fixed to each other by press-fit.

The intermediate cylinder 222 is the same as the intermediate cylinder 122 described in connection with the embodiment, except that the outer diameter of the intermediate cylinder 222 is constant.

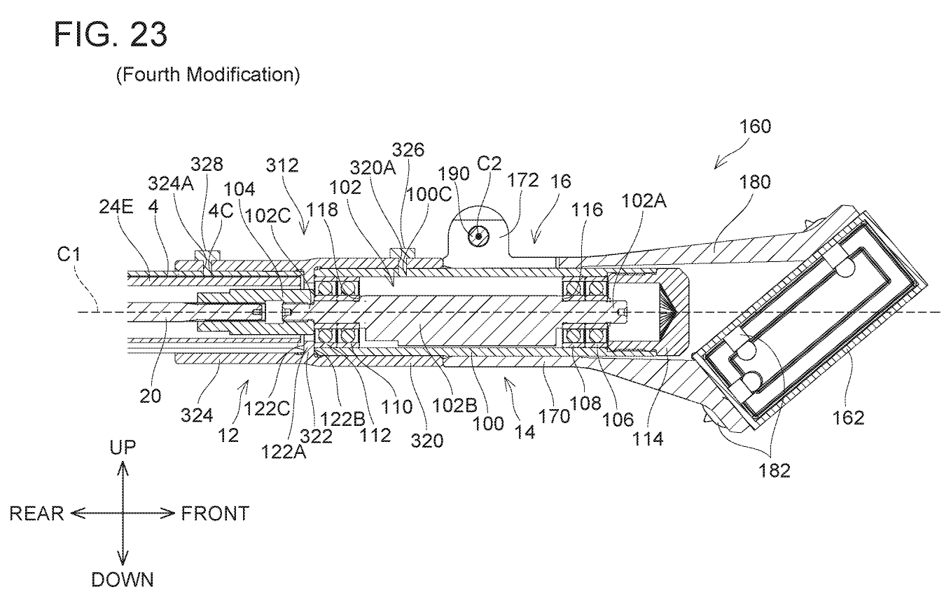

(Fourth Modification) Referring to FIG. 23, a screed according to a fourth modification is described. The screed according to the fourth modification is different from the screed 2 according to the embodiment in the configurations of the operation rod 4, the cylinder 100 of the eccentric member accommodating part 14, and a front connector 312. Further, the screed according to the fourth modification is also different from the screed 2 according to the embodiment in how the operation rod 4 and the eccentric member accommodating part 14 are coupled to the front connector 312.

As illustrated in FIG. 23, the operation rod 4 has a fastening hole 4C. The cylinder 100 of the eccentric member accommodating part 14 has a fastening hole 100C.

The front connector 312 comprises a front fastening portion 320, an intermediate cylinder 322, and a rear fastening portion 324. The front fastening portion 320 and the rear fastening portion 324 each have a cylindrical shape. The front fastening portion 320 extends forward from the front end of the intermediate cylinder 322. The front fastening portion 320 covers the outer surface of the rear end portion of the cylinder 100 of the eccentric member accommodating part 14. The inner diameter of the front fastening portion 320 is the same as the outer diameter of the cylinder 100. A fastening hole 320A is formed in the front fastening portion 320, and the fastening hole 320A corresponds to the fastening hole 100C in the cylinder 100 of the eccentric member accommodating part 14. In this modification, the rear end portion of the cylinder 100 is fixed to the front fastening portion 320 by a fastener 326 being screwed into the fastening hole 100C of the cylinder 100 and the fastening hole 320A of the front fastening portion 320.

The rear fastening portion 324 extends rearward from the rear end of the intermediate cylinder 322. The rear fastening portion 324 covers the outer surface of the front end portion of the operation rod 4. The inner diameter of the rear fastening portion 324 is the same as the outer diameter of the operation rod 4. A fastening hole 324A is formed in the rear fastening portion 324, and the fastening hole 324A corresponds to the fastening hole 4C in the operation rod 4. In this modification, the front end portion of the operation rod 4 is fixed to the rear fastening portion 324 by a fastener 328 being screwed into the fastening hole 4C of the operation rod 4 and the fastening hole 324A of the rear fastening portion 324.

The intermediate cylinder 322 is the same as the intermediate cylinder 122 described in connection with the embodiment, except that the outer diameter of the intermediate cylinder 322 is constant. This modification can achieve the same effects as those of the embodiment.

(Fifth Modification) The front connector 12 described in connection with the embodiment may comprise the rear press-fit portion 224 or the rear fastening portion 324 instead of the rear clamp portion 124. The front connector 12 described in connection with the embodiment may comprise the front press-fit portion 220 or the front fastening portion 320 instead of the front clamp portion 120. The front connector 212 described in connection with the third modification may comprise the rear fastening portion 324 instead of the rear press-fit portion 224. The front connector 212 described in connection with the third modification may comprise the front fastening portion 320 instead of the front press-fit portion 220.

(Sixth Modification) The intermediate cylinder 122 of the front connector 12 described in connection with the embodiment may not comprise the flange 122A. In this modification, a flange projecting radially inward may be located on the rear end portion of the cylinder 100 of the eccentric member accommodating part 14. In another modification, the flange 122A may not have an annular shape. The intermediate cylinder 122 may comprise a projection projecting radially inward from its upper portion or lower portion, although this is merely an example.

(Seventh Modification) The size of the leveler 162 in the longitudinal direction may be in the range of 800 mm to 2400 mm or in the range of 900 mm to 1800 mm.

(Eighth Modification) The size of the screed 2 in the front-rear direction may be in the range of 1300 mm to 1800 mm or in the range of 1500 mm to 1800 mm.

(Ninth Modification) The motor 36 may be a brushed motor.

(Tenth Modification) The leveler unit 16 may not comprise the lever 174. In this modification, the fastening unit 176 may be configured to be directly operated by the user using a tool.

(Eleventh Modification) The screed 2 may not comprise the loop handle 6. In this modification, the screed 2 may comprise a U-shaped handle or may not comprise a handle.

(Twelfth Modification) The operation rod 4 may be constituted of magnesium or zinc. The leveler 162 may be constituted of magnesium or zinc.

(Thirteenth Modification) The plurality of bearing units 22A to 22F and the plurality of liners 24A to 24E may not be located within the operation rod 4.

(Fourteenth Modification) The housing 8 may not comprise the battery case 34. In another modification, the battery cover may be detachably attached to the battery case 34.

(Fifteenth Modification) The screed 2 may not comprise the front mounting portion 60. That is, the screed 2 may comprise a single mounting portion. In this modification, the connectors 404A, 406A of the shoulder strap 400 and the connectors 504A, 506A of the tether strap 500 are configured to be attached to the rear mounting portion 62.

(Sixteenth Modification) The screed 2 may not comprise the rear mounting portion 62. In this modification, the connectors 404A, 406A of the shoulder strap 400 and the connectors 504A, 506A of the tether strap 500 are configured to be attached to the front mounting portion 60.

(Seventeenth Modification) At least one of the rear mounting portion 62 and the front mounting portion 60 may be located in a right portion, front portion, or lower portion of the housing 8.

(Eighteenth Modification) At least one of the rear mounting portion 62 and the front mounting portion 60 may be located on the rear grip 30C.

(Nineteenth Modification) The rear mounting portion 62 may be located forward of the operation surface 50A of the trigger switch 50.

(Twentieth Modification) At least one of the rear mounting portion 62 and the front mounting portion 60 may project from the upper surface of the housing 8 (i.e., the upper surface of the upper grip 30B). For example, the rear mounting portion 62 may comprise a projection projecting from the upper surface of the upper grip 30B and a mounting hole penetrating the projection in the right-left direction.

(Twenty-first Modification) The screed 2 may comprise a mounting portion located on the operation rod 4 instead of the front mounting portion 60.

(Twenty-second Modification) The number of mounting portions the screed 2 comprises is not limited to one or two; it may be three or more. For example, the screed 2 may comprise a mounting portion located on the operation rod 4 in addition to the front mounting portion 60 and the rear mounting portion 62.

What is claimed is:

1. A screed comprising:
a motor;
a housing accommodating the motor, wherein the housing comprises a first mounting portion to which a battery pack or an adapter is detachably attached;
a tubular operation rod constituted of metal, wherein the operation rod extends from the housing toward a first side in a specific direction and accommodates a drive shaft connected to the motor;
an eccentric member accommodating part disposed on the first side to the operation rod in the specific direction, wherein the eccentric member accommodating part accommodates an eccentric member connected to the drive shaft and a plurality of bearings that support the eccentric member such that the eccentric member is rotatable;
a connector connecting the operation rod to the eccentric member accommodating part in the specific direction; and
a leveler connected to the eccentric member accommodating part.

2. The screed as in claim 1, further comprising a second mounting portion coupled to the leveler, wherein the eccentric member accommodating part is configured to be detachably attached to the second mounting portion,
wherein the plurality of bearings includes at least one first bearing and at least one second bearing, wherein the at least one first bearing is disposed in a first end portion of the eccentric member accommodating part, the first end portion is a portion of the eccentric member accommodating part located on a second side in the specific direction, which is opposite to the first side, and wherein the at least one second bearing is disposed in a second end portion of the eccentric member accommodating part and the second end portion is a portion of the eccentric member accommodating part on the first side,
the connector comprises a first cover configured to cover the first end portion of the eccentric member accommodating part, and
the second mounting portion comprises a second cover configured to cover the second end portion of the eccentric member accommodating part.

3. The screed as in claim 1, wherein the connector comprises at least one of a first clamp configured to clamp the operation rod and a second clamp configured to clamp the eccentric member accommodating part.

4. The screed as in claim 3, wherein the connector comprises both the first clamp and the second clamp.

5. The screed as in claim 1, wherein the connector comprises a projection projecting inward from an outer peripheral portion of the connector,
wherein among the plurality of bearings, a specific bearing positioned at most second-side position in the specific direction contacts the projection, and
wherein the second side is opposite to the first side in the specific direction.

6. The screed as in claim 1, wherein a weight of the screed with the battery pack attached to the first mounting portion is in a range of 5.0 kg to 6.0 kg.

7. The screed as in claim 1, wherein a size of the screed in the specific direction is in a range of 1,000 mm to 2,000 mm.

8. The screed as in claim 1, wherein a size of the leveler in a longitudinal direction perpendicular to the specific direction is in a range of 800 mm to 3,000 mm.

9. The screed as in claim 1, wherein the motor is a brushless motor.

10. The screed as in claim 1, further comprising:
a second mounting portion coupled to the leveler, wherein the eccentric member accommodating part is configured to be detachably attached to the second mounting portion; and
a lever pivotably supported by the second mounting portion,
wherein the lever is configured to move between a first position where the eccentric member accommodating part is attachable to the second mounting portion and a second position where the eccentric member accommodating part is not attachable to the second mounting portion.

11. The screed as in claim 1, wherein the operation rod is constituted of aluminum, magnesium, or zinc.

12. The screed as in claim 2, wherein the connector comprises both a first clamp configured to clamp the operation rod and a second clamp configured to clamp the eccentric member accommodating part,
wherein the connector comprises a projection projecting inward from an outer peripheral portion of the connector,
wherein among the plurality of bearings, a specific bearing positioned at most second-side position in the specific direction contacts the projection,
wherein a weight of the screed with the battery pack attached to the first mounting portion is in a range of 5.0 kg to 6.0 kg,
wherein a size of the screed in the specific direction is in a range of 1,000 mm to 2,000 mm,
wherein a size of the leveler in a longitudinal direction perpendicular to the specific direction is in a range of 800 mm to 3,000 mm,
wherein the motor is a brushless motor,
the screed further comprises:
a second mounting portion coupled to the leveler, wherein the eccentric member accommodating part is configured to be detachably attached to the second mounting portion; and
a lever pivotably supported by the second mounting portion,
wherein the lever is configured to move between a first position where the eccentric member accommodating part is attachable to the second mounting portion and a second position where the eccentric member accommodating part is not attachable to the second mounting portion,
the operation rod is constituted of aluminum, magnesium, or zinc.
